(19) United States
(12) Patent Application Publication
(10) Pub. No.: US 2024/0292236 A1
(43) Pub. Date: Aug. 29, 2024

(54) METHODS AND APPARATUSES FOR PROVISIONING A WIRELESS DEVICE WITH PREDICTION INFORMATION

(71) Applicant: Telefonaktiebolaget LM Ericsson (publ), Stockholm (SE)

(72) Inventors: Henrik RYDÉN, Stockholm (SE); Andres REIAL, Höllviken (SE); Sina MALEKI, Malmö (SE); Ali NADER, Malmö (SE)

(73) Assignee: Telefonaktiebolaget LM Ericsson (publ), Stockholm (SE)

(21) Appl. No.: 18/573,783

(22) PCT Filed: Jun. 29, 2021
(86) PCT No.: PCT/EP2021/067908

§ 371 Date: Dec. 22, 2023

(51) Int. Cl. H04W 24/02; G06N 3/0455

(52) U.S. Cl. CPC H04W 24/02; G06N 3/0455

(57) ABSTRACT

The present disclosure relates to a computer-implemented method (100), performed by a first network node, for provisioning a wireless device with prediction information for allowing the wireless device to predict a radio signal measurement between the wireless device and a base station, wherein the prediction information comprises a denoising autoencoder and at least one candidate noising pattern. The method comprises: receiving (110), from the wireless device, wireless device capability information: obtaining (120), based on the wireless device capability information, the denoising autoencoder and/or the at least one candidate noising pattern for predicting a radio signal measurement; and transmitting (130) an indication of the prediction information to the wireless device. The present disclosure also relates to a first network node, a wireless device and a computer program.

### TECHNICAL FIELD

The present disclosure relates to methods for provisioning a wireless device with prediction information. The present disclosure also relates to a first network node, a wireless device and a computer program.

### BACKGROUND

Artificial Intelligence (AI) and Machine Learning (ML) applications have found widespread use in telecommunications systems. Their use has led to various advantages. There is thus an ongoing discussion in the 3^{rd} generation project partnership (3GPP) on how to support AI and ML applications in future networks. The application of AI and ML processes is enabled by large scale data collection and can be expected to result in improvements in, for example, energy efficiency and Radio Access Network (RAN) optimization.

Many AI and ML models focussed on RAN applications are directed towards the signalling aspect of RAN systems. By signalling a model to the UE, some of the computation involved in AI and ML solutions can move away from the network and instead be computed at the UE. Increasing AI and ML computation at the UE can provide several benefits. For example, the UE does not need to transmit model inputs to the network because the model is already located at the UE, which can save power at the UE. In another example, the model can be executed more frequently by the UE, for example, whenever the UE receives new information, which can be provided as an input to the model. In some examples, increasing the computation performed by the UE, thus saves resources at an associated base station.

A further focus of 3GPP is energy efficiency, and, in particular, how to leverage AI and ML to improve energy efficiency. For example, AI and ML led solutions for energy efficiency are expected to be a vital component in 6G systems. Determining what part of the intelligence of an AI or ML solution should reside in the UE or in the network is expected to be a key area to consider for energy efficiency solutions for 6G systems.

At RP-202650, 3GPP TSG-RAN WG Meeting #90-e, e-Meeting, December 7th-11th, 2020, AI-based solutions for physical (PHY) layer enhancement in RAN systems were discussed. One of the discussed use cases was to use AI to predict radio signal quality between a UE and a base station. An AI trained model may be applied to, based on measurements on a subset of beams, predict radio signal measurements for the other beams. The UE thus only needs to measure a subset of the beams and, based on these measurements, the AI trained model can predict the remaining measurements. This can reduce the amount of measurements that the UE needs to perform by up to 75%, which thus saves UE power and improves efficiency.

Thus, AI and ML solutions present a useful mechanism by which UE energy efficiency can be improved.

### SUMMARY

It is an aim of the present disclosure to provide a method, a first network node, a wireless device and a computer program product which at least partially address one or more of the challenges discussed above. It is a further aim of the present disclosure to provide a method, a first network node, a wireless device and a computer program product, which aim to improve UE energy efficiency by predicting a radio signal measurement.

Examples according to the present disclosure may provision a UE with prediction information for allowing a UE to predict a radio signal measurement. In some examples, predicting a radio signal measurement, as opposed to measuring the measurement, may save power at the UE thus improving UE energy efficiency. Furthermore, the prediction information may be obtained based on UE capability information. As such the prediction information may be obtained taking into account UE-specific needs, which may thus lead to more accurate radio signal measurement predictions or prediction information that may be used more frequently by a UE, or may lead to even greater power saving and/or efficiency at the UE.

According to a first aspect there is provided a computer-implemented method, performed by a first network node, for provisioning a wireless device with prediction information for allowing the wireless device to predict a radio signal measurement between the wireless device and a base station, wherein the prediction information comprises a denoising autoencoder and at least one candidate noising pattern. The method comprises: receiving, from the wireless device, wireless device capability information; obtaining, based on the wireless device capability information, the denoising autoencoder and/or the at least one candidate noising pattern for predicting a radio signal measurement; and transmitting an indication of the prediction information to the wireless device.

Examples of the present disclosure may also provision a UE with prediction information for allowing a UE to predict a radio signal measurement where the UE has the flexibility to assess whether to predict a radio signal measurement or not. The UE may make such an assessment based on the UE's own needs at a given moment in time. The UE can thus take such a decision based on information not available to the network, such as battery status or QoS targets, which leads to the UE making a decision to predict a radio signal measurement tailored to the UE's needs.

According to a second aspect there is provided a first network node for provisioning a wireless device with prediction information for allowing the wireless device to predict a radio signal measurement between the wireless device and a base station, wherein the prediction information comprises a denoising autoencoder and at least one candidate noising pattern. The first network node comprises processing circuitry configured to: receive, from the wireless device, wireless device capability information; obtain, based on the wireless device capability information, the denoising autoencoder and/or the at least one candidate noising pattern for predicting a radio signal measurement; and transmit an indication of the prediction information to the wireless device.

According to a third aspect there is provided a computer-implemented method, performed by a wireless device, for obtaining prediction information for allowing the wireless device to predict a radio signal measurement between the wireless device and a base station, wherein the prediction information comprises a denoising autoencoder and at least one candidate noising pattern. The method comprises: transmitting, to a first network node, wireless device capability information; and receiving, from the first network node, an indication of the prediction information, wherein the prediction information is obtained based on the wireless device capability information.

According to a fourth aspect there is provided a wireless device for obtaining prediction information for allowing the wireless device to predict a radio signal measurement between the wireless device and a base station, wherein the prediction information comprises a denoising autoencoder and at least one candidate noising pattern. The wireless device comprises processing circuitry configured to: transmit, to a first network node, wireless device capability information; and receive, from the first network node, an indication of the prediction information, wherein the prediction information is obtained based on the wireless device capability information.

According to a fifth aspect there is provided a computer-implemented method, performed by a wireless device, for assessing whether to predict a radio signal measurement between the wireless device and a base station. The method comprises obtaining an indication of prediction information for predicting a radio signal measurement between the wireless device and the base station, wherein the prediction information comprises a denoising autoencoder and at least one candidate noising pattern; and assessing whether to predict the radio signal measurement between the wireless device and the base station using the prediction information based on one or more local criteria associated with the wireless device.

According to a sixth aspect there is provided a wireless device for assessing whether to predict a radio signal measurement between the wireless device and a base station. The wireless device comprises processing circuitry configured to: obtain an indication of prediction information for predicting a radio signal measurement between the wireless device and the base station, wherein the prediction information comprises a denoising autoencoder and at least one candidate noising pattern; and assess whether to predict the radio signal measurement between the wireless device and the base station using the prediction information based on wireless device criteria.

According to a seventh aspect there is provided a computer program product comprising a computer readable medium, the computer readable medium having computer readable code embodied therein. The computer readable code being configured such that, on execution by a suitable computer or processor, the computer or processor is caused to perform a method according to the first, third or fifth aspects.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a computer-implemented method for provisioning a wireless device with prediction information;

FIG. 2 is a flow chart illustrating process steps in a computer-implemented method for obtaining prediction information;

FIGS. 3a and 3b illustrate example radio signal measurements;

FIG. 4 is a graph illustrating an error associated with radio signal measurement predictions;

FIG. 5 is a graph illustrating reconstruction error associated with measured and predicted radio signal measurements;

FIG. 6 is an example of a feed-forward neural network (NN);

FIG. 7 is a signalling diagram illustrating a message flow between a first network node and a UE;

FIG. 8 is a schematic diagram illustrating base stations over a geographic area;

FIG. 9 is a flowchart illustrating process steps in a computer-implemented method for assessing whether to predict a radio signal measurement;

FIG. 10 is a block diagram illustrating functional modules in a first network node;

FIG. 11 is a block diagram illustrating functional modules in a wireless device;

FIG. 12 is another block diagram illustrating functional modules in a wireless device.

### DETAILED DESCRIPTION

The present disclosure relates to methods for provisioning a wireless device with prediction information for allowing the wireless device to predict a radio signal measurement between the wireless device and a base station. For the purposes of the present disclosure, a wireless device may be referred to as a user equipment (UE) and the two terms may be used interchangeably to refer to any device capable of communicating with a base station.

Methods according to the present disclosure involve provisioning a UE with a denoising autoencoder (DAE), which is able to predict radio signal measurements based on a subset of radio signal measurements.

As one skilled in the art will be aware, an autoencoder is a type of machine learning algorithm that may be used to learn efficient data representations to concentrate data. Autoencoders are trained to take a set of input features and reduce the dimensionality of the input features with minimal information loss. An autoencoder is divided into two parts, an encoding part or encoder and a decoding part or decoder.

The encoder and decoder may comprise, for example, deep neural networks comprising layers of neurons. An encoder successfully encodes or compresses the data if the decoder is able to restore the original data stream with a tolerable loss of data. In autoencoders where there are more nodes in the hidden layer than there are inputs, the autoencoders typically learn an identity function, which implies that the output equals the input with no loss of data.

As will be described in more detail below, a DAE corrupts the input data on purpose by randomly turning some of the input values to, for example, zero. This can enable the neural network to perform denoising, which involves reconstructing the zero-valued input features. DAEs have been, for example, employed to improve image quality of low-resolution pictures.

Through the denoising process, the DAE can thus predict radio signal measurements based on a subset of measured radio signal measurements. Thus, instead of the UE measuring on all beams from a cell, the UE may measure a subset of the beams and predict the remaining radio signal measurement(s) for the remaining beam(s) using the DAE. Thus, by measuring a subset of the beams rather than all beams, the UE power consumption is reduced, and therefore efficiency is improved.

As will be described in more detail below, known methods which involve reducing or relaxing UE radio signal measurements involve the network controlling configuration settings, which causes a UE to reduce the number of measurements. This can result in the network being unaware of UE capability information, such as, UE hardware or computational information, which can affect the UE's suitability to be able to accurately predict a radio signal measurement.

In order to provide additional context to the description of methods according to the present disclosure, there now follows a discussion of techniques that aim to improve UE efficiency based on radio signal measurement relaxation and prediction.

3GPP has relaxed signalling measurement requirements in some instances in order to provide energy saving measures at the UE. 3GPP specification TR 38.840 v 16.0.0 section 6.4 provides such measurement relaxation. This section of TR 38.840 describes that studies were made to relax the serving and neighbour cell measurements for a new radio (NR) UE, considering mobility-related aspects. On the basis of the study, RRM measurement relaxation for a serving cell is down-prioritized for a UE in any RRC state. RRM measurements for neighbour cells in both intra and inter-frequencies can be relaxed for UEs in RRC_CONNECTED and RRC_IDLE/INACTIVE. Measurement relaxation can also occur for UEs in RRC_CONNECTED, which are under network control.

3GPP specification TR 38.840 v 16.0.0, section 6.4 also studied the relaxed monitoring criterion under which a UE may relax RRM measurements. The relaxed monitoring criteria may include the following aspects, but are not limited to:
UE mobility status (e.g. serving cell variation, speed, movement, direction, cell re-selection, UE type . . . )
Link quality (e.g. serving cell threshold/quality, position in cell . . . )
Serving cell beam status (e.g. beam change, direction, beam specific link condition . . . )

The exact relaxation criteria are yet to be defined, but the following two conditions may be treated with higher priority when determining whether to relax measurements:
1) when the UE is not at cell edge,
2) when the UE is stationary or with low mobility.

For energy efficiency reasons it may be beneficial to perform RRM measurement relaxation by allowing measurements with longer intervals, and/or by reducing the number of cells, carriers or Synchronization Signal Blocks (SSB) to be measured.

Due to the densification of networks and increasing number of frequencies, the number of UE measurements can be large, which thus results in increased drain on UE power. One option to reduce the UE measurements are the relaxed monitoring criteria for non-serving cell measurements in idle mode operation, such as described above. However, such solutions have the drawback that the UE makes decisions based on outdated information of the non-measured signals. Furthermore, the configuration of features such as relaxed monitoring is typically provided on the cell level e.g., through the broadcast channel. Thus, the configuration for relaxed monitoring is applicable for the entire cell and for all the UEs connected to the cell. Depending on cell size and/or shape a single configuration such as this may not be optimal for all areas of the cell. Furthermore, even though the relaxed monitoring configuration is consumed by all the UEs, the outcome and behaviour of UEs may differ due to different UE characteristics. For example, different hardware architectures and components such as receiver chains may perform differently for a given relaxed monitoring configuration.

In beamforming operations, several techniques have been developed, which can predict the highest quality beam of a cell based on a subset of beams from said cell. For example, such a beam prediction can be made in millimetre wave (mmW) beam management or for link adaptation prior to data scheduling. Such predictions, however, require the network to preconfigure the measurements that are required in order to make an accurate prediction of other beams. Thus, in known prediction techniques, there is reduced flexibility for the UE to select which beams it intends to predict. For example, the UE might be able to be in sleep mode if it had not been configured with a measurement resource in a certain timeframe.

Moreover, Quality of Service (QOS) targets that the UE is required to meet may mean that an accurate beam selection is required, and thus QoS targets may dictate that the UE may not be able to tolerate the prediction error associated with a beam prediction. Also, for a network to predict the optimal beam for a UE, the network needs the UE measurement report for a plurality of beams, which thus consumes energy at the UE.

Other types of measurements that also may contribute significantly to UE energy consumption include radio link management (RLM) and beam failure detection (BFD), inter-frequency/inter-carrier measurements for RRM, etc.

Thus, in known beam prediction schemes there is typically a trade-off between energy efficiency and QoS. One problem associated with such schemes is that the network is not aware of the UE energy consumption requirements and similarly, at the device, there is an uncertainty in how the prediction actions may affect QoS. There is thus a need for an improved AI and ML framework for extracting relevant information from limited UE measurement sets where the extraction criteria can be controlled by the network and also account for UE-specific scenario aspects not directly observable by the network, such as QoS targets.

Examples of the present disclosure thus provide methods and apparatus that can improve UE energy efficiency by predicting radio signal measurements based on UE capability information.

Some examples according to the present disclosure involve a UE transmitting UE capability information to a first network node, based on which, the first network node obtains prediction information for allowing the wireless device to predict a radio signal measurement between the wireless device and a base station. The prediction information, which comprises the DAE, may thus be indicated to the UE, for example by transmitting the prediction information to the UE. In this way, the prediction information is obtained based on the UE capability information, which thus provides a radio signal measurement prediction scheme, which may be more suited to UE characteristics, such as UE hardware architecture.

Some examples according to the present disclosure involve a UE determining whether to utilise prediction information to predict a radio signal measurement, based on one or more local UE specific criteria. In this way, a UE is able to decide whether or not using the prediction information to predict a radio signal measurement would be beneficial to the UE or not.

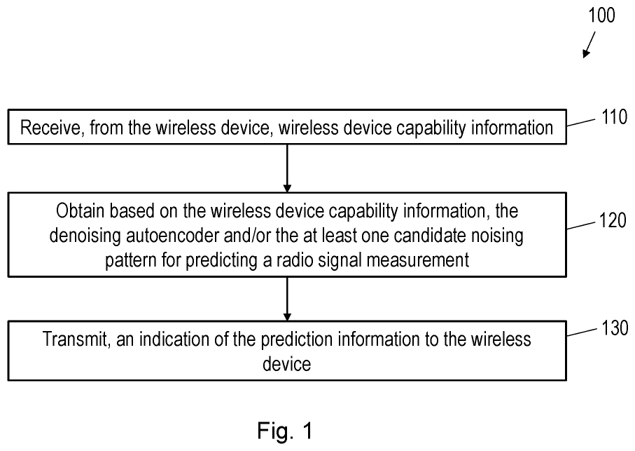

FIG. 1 illustrates process steps in a computer-implemented method 100. The method may be for provisioning a wireless device with prediction information for allowing the wireless device to predict a radio signal measurement between the wireless device and a base station, wherein the prediction information comprises a denoising autoencoder (DAE) and at least one candidate noising pattern.

As will be described in more detail below, the candidate noising pattern may provide an indication to a wireless device of which beams from a cell may be predicted and which beams may be measured in order for the DAE to predict the remaining beams. The method 100 may be performed by a first network node, which may comprise a physical or virtual node, and may be implemented in a computing device or server apparatus and/or in a virtualized environment, for example in a cloud, edge cloud or fog deployment. In some examples, the first network node may comprise the base station. In some examples, the first network node may comprise a core network node. For example a core network node may comprise: a, Access and Mobility Management Function (AMF), Mobility Management Entity (MME), a Packet Data Network Gateway (P-GW), a Service Capability Exposure Function (SCEF), or the like. Furthermore, corresponding core network nodes of 6G systems may be configured to perform methods according to the present disclosure. It will be appreciated that in examples in which the first network node does not comprise a base station any disclosure of transmissions between the first network node and the wireless device may be considered to take place via a base station.

The method 100 comprises, in a first step 110, receiving, from the wireless device, wireless device capability information. For example, the wireless device capability information may comprise wireless device hardware information or computational capability information. In some examples, the wireless device capability information may be received at the first network node via a base station.

The method 100 further comprises, in step 120, obtaining, based on the wireless device capability information, the DAE and/or the at least one candidate noising pattern for predicting a radio signal measurement. The DAE and/or the at least one candidate noising pattern are obtained based on the wireless device capability information, and thus wireless device-specific information is considered in obtaining the DAE and/or the at least one candidate noising pattern. As will be described in more detail below, in some examples, the first network node may train the DAE to predict a radio signal measurement based on a plurality of initial noising patterns. The first network node may then identify the at least one candidate noising pattern from the plurality of initial noising patterns. In some examples, the first network node may identify a pre-trained DAE and/or the at least one candidate noising pattern based on the wireless device capability information.

The method 100 further comprises, in step 130, transmitting an indication of the prediction information to the wireless device. In some examples, the indication may be transmitted by the first network node via the base station. In some examples, the indication may comprise the prediction information comprising the DAE and/or the at least one candidate noising pattern. In other words, transmitting the indication of the prediction information to the wireless device may comprise transmitting the prediction information to the wireless device.

In some examples, the wireless device may be provisioned with a plurality of DAEs and noising patterns. The first network node may then transmit an indication of the prediction information to the wireless device, which indicates to the wireless device which DAE and candidate noising pattern(s) could be used by the wireless device for predicting a radio signal measurement.

For example, the wireless device may be preconfigured with a plurality of DAEs and noising patterns. Transmitting the indication of the prediction information to the wireless device may therefore comprise transmitting control information, based on the wireless device capability, to the wireless device, wherein the control information may be configured to identify a DAE and at least one associated candidate noising pattern preconfigured at the wireless device. By preconfiguring the wireless device with DAEs and noising patterns, the amount of data that needs to be transmitted to the wireless device to provide the prediction information may therefore be greatly reduced.

In some examples, the prediction information may further comprise: a plurality of DAEs and selection information, wherein the selection information is configured to indicate to the wireless device to select one of the plurality of DAEs to predict the radio signal measurement. In some examples, the UE may select, based on the selection information, one of the plurality of DAEs to predict the first radio signal measurement.

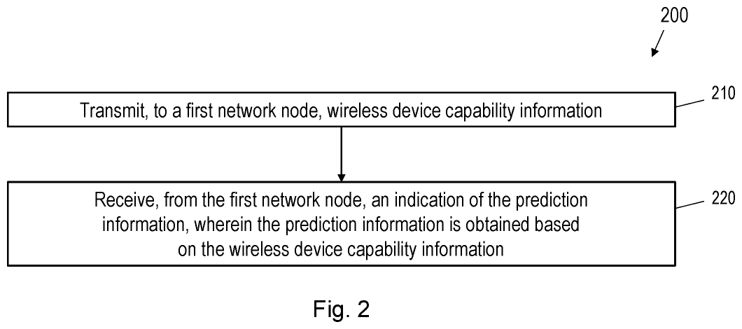

FIG. 2 illustrates process steps in a computer-implemented method 200 for obtaining prediction information for allowing the wireless device to predict a radio signal measurement between the wireless device and a base station, wherein the prediction information comprises a DAE and at least one candidate noising pattern. The method is performed by a wireless device which may comprise any device capable of communicating with a base station such as a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

The method 200 comprises in step 210, transmitting, to a first network node, wireless device capability information. In some examples, the wireless device capability information may comprise wireless device hardware information or computational capability information for the wireless device. In some examples, the wireless device capability information is transmitted to the first network node via a base station. It will be appreciated that in examples in which the first network node does not comprise a base station any disclosure of transmissions between the first network node and the wireless device may be considered to take place via a base station.

The method 200 further comprises receiving, from the first network node, an indication of the prediction information, wherein the prediction information is obtained based on the wireless device capability information. As described above, the prediction information is obtained based on the wireless device capability information, which can thus lead to a radio signal prediction measurement scheme for a wireless device, which takes into account wireless device specific information. In some examples, the indication of the prediction information is received from the first network node via a base station.

The prediction information may be based on the wireless device capability information in one or more of the following ways:
the DAE may be trained based on the wireless device capability information;
the DAE may be selected from a plurality of pretrained DAEs based on the wireless device capability information;
the at least one candidate noising pattern may be designed based on the wireless device capability information;
the at least one candidate noising pattern may be selected from a plurality of initial candidate noising patterns at least partly based on the wireless device capability information.

Examples of how the prediction information may be based on the wireless device capability information will be described in more detail throughout this disclosure.

As described above, examples according to the present disclosure may comprise a first network node training a DAE to predict radio signal measurements based on a plurality of noising patterns.

For example, obtaining the DAE and/or the at least one candidate noising pattern, as described in step 120 above, may comprise training the DAE to predict a radio signal measurement based on each of the at least one candidate noising pattern. For example, training the DAE to predict a radio signal measurement based on each of the at least one candidate noising pattern may comprise: obtaining a plurality of sets of radio signal measurements between the wireless device and the base station; and applying each of a plurality of initial noising patterns to one or more of the plurality of sets of radio signal measurements to generate a noised dataset, wherein each of the plurality of initial noising patterns masks at least one radio signal measurement when applied to a set of radio signal measurements.

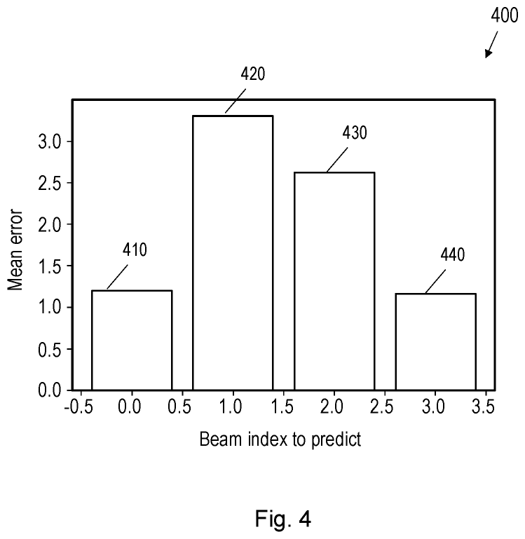

The training may thus further comprise: training the DAE to predict the at least one masked radio signal measurement for each initial noising pattern; determining a respective reconstruction error of the DAE associated with each respective initial noising pattern; and identifying the at least one candidate noising pattern from the plurality of initial noising patterns based on the respective reconstruction errors associated with the plurality of initial noising patterns. An example of how the at least one candidate noising pattern may be identified from the plurality of initial noising patterns will be described later with reference to FIG. 4.

The example now described provides one such example method of training a DAE to predict a radio signal measurement.

In one example, a first network node trains a DAE for predicting radio signal measurements between a UE and a base station providing a serving cell. In this example, the cell is based on a simulation scenario and the base station transmits four SSB beams. This simulation was developed to replicate the conditions of a densely populated urban area spanning a geographical area of 2×2 Km comprising buildings and structures of varying heights.

This example simulation may be described as follows:

The area is served by a macro layer deployed on 3.5 GHz carrier. In the macro layer, the inter-site distance of the 3-sector sites is on average 400 m, which depends on the deployment of antennas on the rooftops in the area. This deployment results in 19 sites and thus 57 cells. The devices are spread in the service area with half of the devices indoors and half outdoors. The 57 macro-cells on the 3.5 GHz frequency are transmitting 4-wide SSB beams. More details of the simulation scenario are described in H. Ryden and R. Moosavi, “Downloadable machine learning for compressed radiolocation applications in radio access networks,” 2020 IEEE Globecom Workshops (GC Wkshps, 2020, pp. 1-6, doi: 10.1109/GCWkshps50303.2020.9367519.

In a first step of training the DAE, the first network node obtains a set of UE reported measurements which, in this example, comprise Reference Signal Received Power (RSRP) data for all four SSB beams of a cell of the above-described scenario. The first network node subsequently applies a plurality of initial noising patterns to the set of radio signal measurements to noise the radio signal measurements.

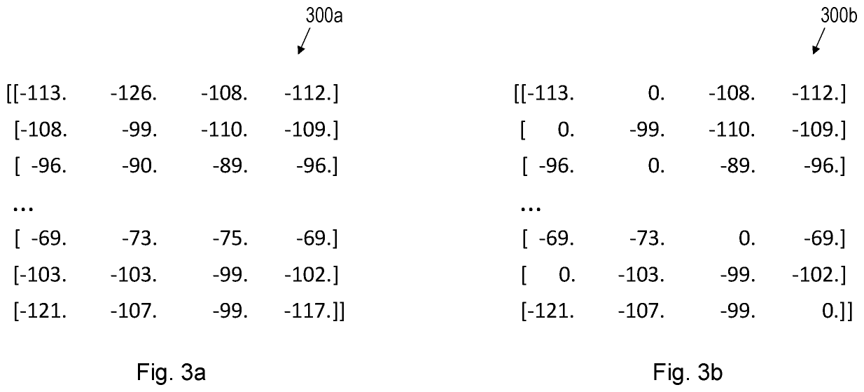

FIGS. 3a & 3b illustrate radio signal measurements obtained from a cell transmitting the four SSB beams from the above-described scenario. FIG. 3a illustrates a set of radio signal measurements 300a, as measured by a UE. FIG. 3b illustrates a noised set of radio signal measurements 300b obtained from the set of radio signal measurements 300a. It will be appreciated that each row of four values illustrated in FIGS. 3a and 3b represents an entry in the set of radio signal measurements 300a or the noised set of radio signal measurements 300b. Each value is representative of a measurement (or masked measurement) on one of the four SSB beams.

As illustrated, for each entry in the set of radio signal measurements 300a one of the four SSB radio signal measurements is masked by a 0 in the noised set of radio signal measurements 300b. The masked value is masked as a result of the application of the plurality of initial noising patterns. In this example, four initial noising patterns ([0,1,1,1], [1,0,1,1], [1,1,0,1], [1,1,1,0]) are each applied to one or more entries in the set of radio signal measurements 300a, where the value ‘0’ masks a radio signal measurement and the value ‘1’ does not mask the radio signal measurement.

In this example, each radio signal measurement in an entry in the set of radio signal measurements 300a may be multiplied by the value in a corresponding position in the applied initial noising pattern in order to generate the noised set of radio signal measurements 300b.

For example, the at least one masked radio signal measurement for each initial noising pattern is masked with a defined value that is the same for each of the plurality of initial noising patterns. Thus, in the example illustrated in FIG. 3b, the defined value comprises ‘0’. However, in other examples the defined value may comprise ‘1’. In other words, if a value is masked by the initial noising pattern the value may be set to, for example “1” in the noised set of radio signal measurements (as opposed to “0” as illustrated in FIG. 3b).

In other examples, other noising patterns may be applied to the radio signal measurements where more than one, for example two radio signal measurements, are masked from entries in the set of radio signal measurements. It will therefore be appreciated that each initial or candidate noising pattern may be a unique configuration to mask one or more radio signal measurements in a set of radio signal measurements. In some examples the nosing patterns are generated by randomly selecting which, and the number of, radio signal measurements that are masked.

Once the set of radio signal measurements have been noised by application of the noising patterns, the first network node trains a model to be able to predict the masked values of the noised radio signal measurements. In one example, the model may comprise a 3-layered feedforward neural network with 8 nodes in each layer. The model may thus form the basis for a DAE to predict a radio signal measurement. For example, a model “F” may be formed which can recreate (with tolerable data loss) the set of radio signal measurements x from the noised data set xₙₒᵢₛₑ, such that F(xₙₒᵢₛₑ)=x.

FIG. 4 illustrates a graph 400 showing an example of average reconstruction errors provided by a model for predicting each of the four SSB beams of the cell (in the example simulation described above). As illustrated, the mean average error for beam 0 and beam 3 is less than 1.5 dB, whereas the mean average error for beam 1 and beam 2 is larger, e.g. greater than 3 dB and 2.5 dB, respectively.

In some examples, identifying the at least one candidate noising pattern for the prediction information may comprise for each noising pattern: determining whether the reconstruction error associated with the noising pattern meets an accuracy criterion; and responsive to the reconstruction error associated with the initial noising pattern meeting the accuracy criterion, identifying the noising pattern as one of the at least one candidate noising patterns for the prediction information.

For example, the prediction for beam 3 is associated with the noising pattern [1,1,1,0]. In one example, the accuracy criterion may comprise a threshold value associated with the mean average error, for example, 1.5 dB. In such examples, noising patterns associated with a prediction that is less than the threshold value may be considered to satisfy the accuracy criterion. In such examples, the noising pattern [1,1,1,0], associated with the beam 3 prediction, will be considered to satisfy the accuracy criterion and thus may comprise a candidate noising pattern, indicated to the UE as part of the prediction information. Similarly, the noising pattern [0,1,1,1] associated with the prediction of beam 0 will also satisfy the accuracy criterion because the associated mean average reconstruction error is also below 1.5 dB. Thus, the noising pattern [0,1,1,1] may also comprise a candidate noising pattern, indicated to the UE as part of the prediction information. However, the noising patterns associated with the predictions for beam 1 and beam 2 will not satisfy the accuracy criterion because their associated mean average error is greater than 1.5 dB. As such, in such an example, the noising patterns [1,0,1,1] and [1,1,0,1] will not be indicated to the UE in the prediction information.

In this example, the prediction information may thus indicate to the UE that, in some examples, the UE may omit measuring beam 0 or beam 3 and predict these measurements. However, in this example, the prediction information may thus also indicate that to perform such a prediction, the UE should always measure beam 1 and beam 2 and cannot predict these radio signal measurements. In some examples, the prediction information may further comprise the respective reconstruction errors associated with each respective candidate noising pattern.

In some examples, obtaining the at least one candidate noising pattern for the prediction information may further be based on wireless device capability information, for example, predicted power saving performances for the wireless device associated with each candidate noising pattern. For example, the first network node may be able to predict that omitting some radio signal measurements and predicting those measurements may provide greater power saving measures for the UE than omitting other radio signal measurements. For example, the first network node may determine that predicting a radio signal measurement that is at the beginning or end of a measurement window for a cell may be associated with a greater power saving measure than radio signal measurements that are not. By predicting such measurements, the UE may either be held in a deep sleep mode for a longer period of time (by predicting radio signal measurements at the beginning of the measurement window) or may switch to deep sleep mode sooner (by predicting radio signal measurements at the end of the measurement window).

In another example, a nosing pattern associated with predicting two or more radio signal measurements that are adjacent one another within a measurement window may be associated with greater power saving than a noising pattern associated with predicting two or more radio signal measurements that are non-adjacent. In such examples, predicting adjacent radio signal measurements may allow the UE to be held in sleep mode over a greater period of time than for a UE to predict non-adjacent radio signal measurements.

Thus, in some examples, obtaining the at least one candidate noising pattern of the prediction information may further comprise obtaining the at least one candidate noising pattern based on predicted power saving performances for the wireless device associated with each candidate noising pattern. In some examples, a first noising pattern configured to mask one or more radio signal measurements that are at a beginning or an end of a measurement window may be associated with a greater power saving performance than a second noising pattern configured to mask one or more radio signal measurements that are not at the beginning or the end of the measurement window. In some examples, a third noising pattern configured to mask radio signal measurements that are adjacent to one another within a measurement window is associated with a greater power saving performance than a fourth noising pattern configured to mask radio signal measurements that are not adjacent to one another in a measurement window.

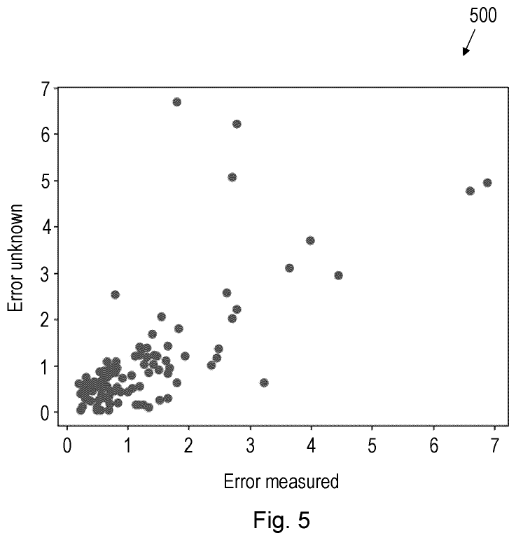

FIG. 5 is a graph 500 illustrating a reconstruction error associated with measured and predicted radio signal measurements. The x-axis, shows the reconstruction error observed from the measured radio signal measurements and the y-axis shows the reconstruction error for the predicted radio signal measurements. Due to the reconstruction of the radio signal measurements by the DAE, a reconstruction error is associated with both the measured and masked radio signal measurements. As illustrated, graph 500 shows a positive correlation between the reconstruction errors associated with measured and predicted radio signal measurements. Thus graph 500 shows that when the predicted or measured radio signal measurements have a large reconstruction error, the UE can expect having a larger error also for the other of the predicted or measured radio signal measurements. Thus, in some examples, the UE may decide whether to predict a radio signal measurement based on the reconstruction error associated with measured and predicted radio signal measurements.

Once the DAE has been trained and the relevant candidate noising pattern(s) identified, this information is indicated to the UE as prediction information (for example as described above with reference to FIGS. 1 and 2).

In some examples, the UE may then predict a radio signal measurement based on the DAE and one of the candidate noising patterns of the prediction information.

In some examples, the UE may identify an event trigger based on the predicted first radio signal measurement; and may transmit the event trigger to the first network node or to the base station. For example, based on a predicted radio signal measurement, the UE may trigger events such as reporting a new strongest SSB beam index. In some examples, the event trigger may comprise an indication that the event trigger is identified based on the predicted radio signal measurement. This indication would allow the network to potentially adjust its response to the event trigger based on the knowledge that the predicted radio signal measurement may not be as accurate as it would have been had it been directly measured.

For example, if the UE is performing random access, the UE may indicate that a radio signal measurement prediction was made via preamble selection or in msg 3. The indication may indicate to the first network node to verify the accuracy of the radio signal measurement on which the event trigger is based. In another example, responsive to selecting a beam on the basis of a predicted radio signal measurement, the UE may adjust the power ramping procedure to accelerate switching to a beam for which the radio signal measurement was actually measured if the UE does not receive a random access response (RAR) after a predetermined number of attempts.

### DAE Training

As described above, the DAE is formed from a ML model trained to predict radio signal measurements based on a subset of radio signal measurements. The model is trained from an initial set of radio signal measurements. These initial radio signal measurements may be obtained via reports received from UEs from, for example, mobility events, beamforming procedures or additional report requests. The measurements may comprise for example: Channel state information reference signal (CSI-RS) measurements from the UE; Service request signal (SRS) measurements at the network; Serving SSB measurements at the UE; Neighbour cell SSB measurements at the UE; Inter-freq. measurements; and Intra-freq. Measurements.

As described above, the prediction information may be obtained based on wireless device capability information. For example, a model may be trained to predict radio signal measurements based on wireless device computational capability information.

For example, when the UE is in an idle mode, the type of radio signal measurements that the UE may predict may be different compared to when the UE is in an active mode, for example, where the UE may perform measurements on reference signals intended for beamforming procedures. As such, in some examples, a first DAE may be trained based on radio measurement signals from one or more UEs in idle mode and a second DAE may be trained on radio signal measurements from a one or more UEs in active mode. Thus, the first DAE may be used to predict radio signal measurements when a UE is in an idle mode and the second DAE used when the UE is in an active mode. For example, the UE may be configured with the second DAE when the UE is in an active mode, and the UE may download the first DAE from the network just before the UE transitions to idle mode.

The wireless device capability information transmitted to the first network node in step 110 and 210 of FIGS. 1 and 2 may therefore comprise an indication of whether the UE is operating in idle or active mode. The first network node may select an appropriate DAE or may train the DAE using appropriate initial radio signal measurements, based on whether the UE is operating in active or idle mode.

In another example, the wireless device capability information may comprise a wireless device type. In these examples a DAE may be trained for a specific wireless device type. For example, a respective DAE may be trained for each of: a Redcap UE; an eMBB UE, or a URLLC UE. In another example, a DAE may be trained for a different UE chipsets.

In another example, the wireless device capability information may comprise a location of a UE. In these examples a DAE may be trained based on the location of the UE. For example, a first DAE may trained based on radio signal measurements obtained from one or more UEs that are a within a certain distance from a base station and a second DAE may trained based on radio signal measurements obtained from one or more UEs that are greater than a certain distance from a base station.

In one example, radio signal measurements output from a simulation may be used for model training. Accurate propagation and deployment simulation models of radio signal measurements may be verified to correspond to real-world observations, for example regarding aspects relevant to beam coverage and dynamics. Such simulation models can be used in the place of UE measurement results and the beam prediction training process can thus use radio signal measurements generated by the simulations.

In some examples, the DAE may be trained using federated learning by using the data locally available in at a UE. For example, the DAE can then be trained by a first network node, which transmits the DAE and the plurality of noising patterns to the UE. The UE may then apply the noising patterns to noise radio signal measurements obtained locally by the UE. The UE may then train the DAE to predict the masked radio signal measurements, in similar manner to that described above. The UE may also compute the reconstruction error associated with each noising pattern. The UE may subsequently transmit the DAE and/or the initial noising patterns to the first network node, once the training at the UE has been completed. The UE may also transmit the reconstruction error associated with each initial noising pattern to the network. The network may thus aggregate the DAE and, if present, reconstruction errors received from the UE with the DAE and reconstruction errors generated by the network. The network may thus form the DAE and candidate noising pattern to be used as the prediction information based on the DAE trained by both the network and the UE. The network may further form the DAE and candidate noising pattern to be used as the prediction information based on the reconstruction error(s) obtained by the network and the reconstruction error(s) obtained by the UE.

Thus, in some examples, the UE may train the DAE to predict a radio signal measurement based on the at least one candidate noising pattern. In some examples, training the DAE to predict a radio signal measurement based on the at least one candidate noising pattern may comprise: receiving, from the first network node, the DAE and a plurality of initial noising patterns; obtaining a plurality of sets of radio signal measurements between the wireless device and the base station; applying each of the plurality of initial noising patterns to one or more of the plurality of sets of radio signal measurements to generate a noised dataset; training the DAE to predict the at least one masked radio signal measurement for each initial noising pattern; determining a respective reconstruction error of the DAE associated for each respective initial noising pattern; and transmitting the DAE, the plurality of initial noising patterns and the respective reconstruction errors to the first network node.

In some examples, training, at the first network node, the DAE to predict the at least one masked radio signal measurement for each initial noising pattern may comprise: transmitting the DAE and the plurality of initial noising patterns to the wireless device, wherein the wireless device is configured to apply the plurality of initial noising patterns to a second plurality of sets of radio signal measurements between the wireless device and the base station to generate a second noised dataset, and train the DAE to predict at least one masked radio signal measurement for each initial noising pattern from the second noised dataset; receiving, from the wireless device, an updated DAE and updated respective reconstruction errors of the DAE associated for each respective initial noising pattern based on the wireless device training; and identifying the at least one candidate noising pattern from the plurality of initial noising patterns based on the updated respective reconstruction errors associated with the plurality of initial noising patterns.

As described above, the model for the DAE can comprise a feedforward neural network. In some examples, the neurons in each layer of the neural network can depend on the number of inputs to the model, which may comprise, for example the number of beams to measure.

### Noising Pattern Information

In some examples, the at least one candidate noising pattern of the prediction information may comprise a bitwise vector (for example, as described above with reference to FIGS. 3a and 3b). For example, the noising pattern of each noising pattern applied to the radio signal measurements may comprise a bitwise vector indicating which radio signal measurements should be measured and which may be predicted. In some examples, an associated performance for each pattern may also be included in the bitwise vector, as described above. In the example described above, a UE may be configured to measure on four SSB beams. In such an example, there are be 24 possible noising patterns, where each noising pattern may be represented as [b₁, b₂, b₃, b₄], where, for example, a value of bᵢ=1 indicates that the UE must measure beam with index i and a value of bᵢ=0 indicates that the UE can predict the beam with index i. However, the UE needs to measure on at least one beam, and therefore not all patterns are valid e.g. [0,0,0,0].

As also described above, each noising pattern indicated or transmitted to the UE as part of the prediction information, may also be signalled along with its associated prediction performance or reconstruction error. For example the noising pattern [1,1,1,0], can be signalled with a mean prediction accuracy to predict the 4^{th} beam with an error of x dBm, and variance of y dBM. As also discussed above, in some examples, the first network node may only include candidate noising patterns that satisfy an accuracy criterion.

In another example, a noising pattern can comprise a reference signal description vector with one or more bitwise vectors. The description list of the reference signal description vector can comprise reference signals from a certain cell and the bitwise vector may indicate to the UE which reference signals from a certain cell can be predicted. For example, the reference signal description vector may comprise [cell-ID 19, cell-ID 29, cell-ID 27, cell-ID 94] and an associated bitwise vector may comprise ([1,1,0,1],[1, 1,1,0]). With these reference signal description vector and bitwise vector values, the UE may thus use the DAE to predict the radio signal measurement for cell-ID 27 and measure all other radio signal measurements or predict the radio signal measurement for cell-ID 94 and measure all other radio signal measurements. In some examples, the reference signal description vector can also comprise a cell frequency and beam ID values.

Thus, in some examples, the UE may select a first noising pattern from the at least one candidate noising pattern, wherein the first noising pattern is configured to mask at least a first radio signal measurement.

### UE Capability Information

As described above, in some examples, a first network node obtains the DAE and/or at least one candidate noising pattern of the prediction information based on UE capability information. This may allow tailored prediction information to be obtained for a UE, which may thus lead to prediction information for allowing the UE to predict a radio signal measurement with improved accuracy.

As described above, in some examples, the UE transmits UE capability information to the first network node. The first network node may obtain prediction information based on the UE capability information. For example, the first network node may train the DAE and identify at least one candidate noising pattern to include in the prediction information based on the UE capability information. In another example, the first network node may select one of a pre-trained DAE and at least one candidate noising pattern based on the UE capability information.

Thus, in some examples, obtaining, by the first network node, the DAE and/or the at least one candidate noising pattern, of the prediction information, may comprise selecting, based on the wireless device capability information, the DAE and/or the at least one candidate noising pattern from a plurality of pre-trained DAEs each associated with at least one predetermined candidate noising pattern.

In some examples, the UE capability information may comprise:
UE manufacturer
UE type, e.g., URLLC, eMBB, Redcap, XR, etc.
Maximum consumed memory of model
Floating point support, e.g. (8-bit/16-bit/32-bit float)
UE computational capabilities, for example in terms of the number of operations per seconds, type of processor (CPU, GPU) and/or number of CPUs. In some examples, the UE computational capabilities could be reported specifically for executing a type of ML model
Type of ML models supported (e.g., decision tree, decision forest, linear regression, feedforward neural network, recurrent neural network, convolutional neural network etc.)
Type of energy efficiency actions the UE can take, e.g., sleep modes, transition time, skipping measurements, beam activation/deactivation, etc. The UE maximum supported computational cost or load for executing a model. This could be expressed, for example, in terms of number of operations and their type that the UE can afford to perform for executing a particular model. In some examples, the UE maximum supported computational cost or load can also be associated with a particular type of UE model. Therefore, in some examples, for each ML model supported by the UE, the UE may report a maximum supported computational cost for executing the model in the UE capability information. The first network node may then choose the most appropriate ML model (type, dimension, etc) for a specific UE based on the UE capability information.

Thus, in some examples, wireless device capability information may comprise at least one of:
a wireless device manufacturer
a wireless device type;
wireless device memory information;
wireless device floating point support;
wireless device number of instructions per second information;
wireless device computational capability information;
wireless device DAE support information; and
one or more wireless device energy efficiency actions.

### Transmitting the DAE in the Prediction Information

In some examples, the DAE forming part of the prediction information may be signalled to the UE using existing model formats, such as, the Open Neural Network Exchange (ONNX), or formats commonly used in ML and AI solutions such as Keras or Pytorch.

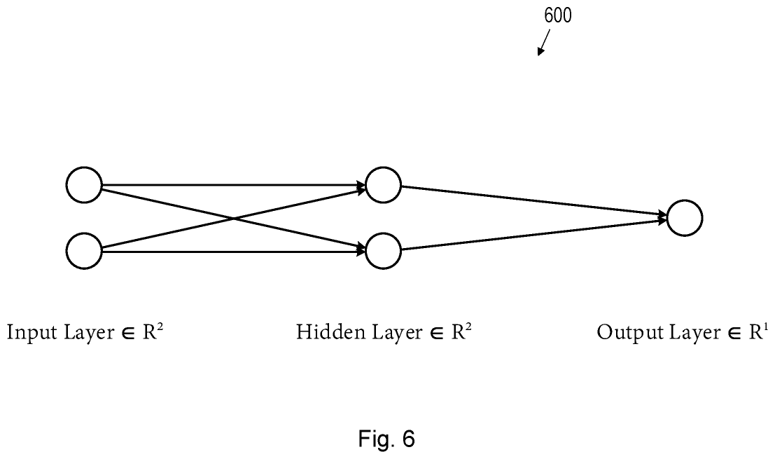

FIG. 6 presents one example of how a DAE comprising a feed-forward neural network (NN), may be transmitted to a UE.

FIG. 6 illustrates an example of a feed-forward NN 600. In some examples, the feed-forward NN 600 may comprise the DAE signalled to the UE in the prediction information. The feed-forward NN 600 may be signalled to the UE using a high-level model description e.g. the framework of the feed-forward NN 600, along with a detailed model information e.g. comprising the weights of each layer of the feed-forward NN 600.

In some examples, the high-level model description may be indicated by the following information:

| Layer (type) | Output Shape | Param # |
|---|---|---|
| dense_5 (Dense) | (None, 2) | 4 |
| activation_2 (Tanh) | (None, 2) | 0 |
| dense_6 (Dense) | (None, 1) | 2 |
| activation_3 (Tanh) | (None, 1) | 0 |

Total params: 6

In some examples, the detailed model information, for example, for each layer e.g. (dense5,dense6) may be indicated in the form:

<tf.Variable ‘dense 5/kernel:0’ shape=(2, 2) dtype=float32, numpy=
array([[−0.04264662, −0.02240936], [−0.01472747, −0.01341971]],
dtype=float32)>,
<tf.Variable ‘dense 6/kernel:0’ shape=(2, 1) dtype=float32,
numpy= array([[ 0.00180571], [−0.02323816]], dtype=float32)>]

It will appreciated that feed-forward NN 600 is one example of a NN model that may be transmitted to a UE as the DAE forming part of the prediction information and in other examples any suitable NN model, such as, a convolutional NN, a recurrent NN, etc may be transmitted to the UE as described above, for example, via the ONNX format.

In one example, the UE may also be preconfigured with a set of DAEs, specified in a standard such as NR or LTE. The UE can be thus equipped with a set of DAEs with a general configuration, e.g., trained on an aggregated dataset from multiple deployment scenarios (real data or simulations). The network, in this example does not need to transmit the model parameters to the UE, but may instead transmit an index of which DAE in the set of DAEs that the UE should use.

### Broadcast or Multicast Prediction Information

In some examples, the indication of the prediction information may be transmitted to a plurality of UEs in a broadcast or a multicast transmission.

For example, the first network node may receive UE capability information from a plurality of UEs. The first network node may determine that prediction information is applicable for each of the plurality of UEs based on the UE capability information from each of the plurality UEs. The first network node may thus use a broadcast or a multicast transmission to indicate the prediction information to each of the plurality of UEs. Indicating the prediction information via a multicast or a broadcast may, in some examples, reduce the network resources used to transmit the prediction information, compared to transmitting the indication of the prediction information to each of the plurality UEs individually via respective unicast transmissions.

In some examples, the first network node may receive UE capability information from a plurality of UEs where the UE capability information may be indicative that one UE is more constrained or limited compared to the other UE(s). The first network node may thus select appropriate prediction information to indicate to each of the plurality of UEs based on the most constrained or limited UE. For example, the UE capability information may indicate that one UE has reduced memory capacity compared the other UEs. The first network node may thus select a DAE and/or noising pattern to use as the prediction information that is applicable for the UE with the reduced memory capacity. The first network node may thus infer that the prediction information for a UE with reduced memory capacity may be applicable for the UEs with greater memory capacity. The first network node may therefore indicate such prediction information to the plurality of UEs in a broadcast transmission. In some examples, the first network node may transmit the prediction information as part of system information (SI), e.g., as part of a system information block number (SIBn), or a new system information block (SIB) specifically designed for AI or ML updates.

Thus, in some examples, transmitting the prediction information to the wireless device may comprise transmitting a unicast transmission, broadcast transmission or a multicast transmission. In some examples, transmitting the prediction information to the wireless device comprises transmitting a broadcast transmission or a multicast transmission and wherein the DAE and/or the at least one candidate noising pattern may be obtained based on wireless device capability information received from a plurality of wireless devices.

### Prediction Information Update Criteria

In some examples according to the present disclosure, the prediction information comprising the DAE and the at least one candidate noising pattern may be updated based on prediction information update criteria.

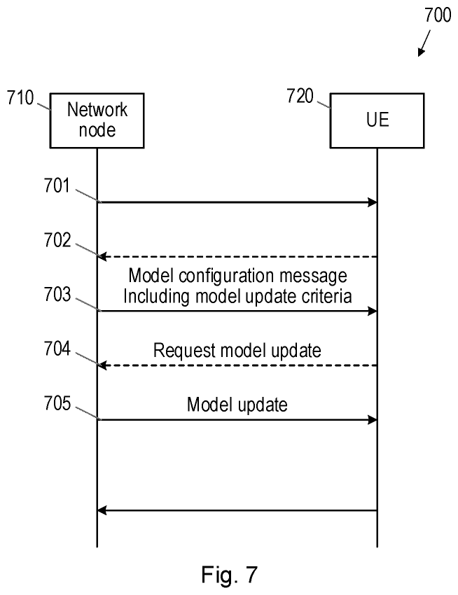

FIG. 7 illustrates a signalling diagram 700 showing example messages transmitted between a first network node 710 and a UE 720.

A first message 701 may be transmitted from the first network node 710 to the UE 720. In some examples the first message may comprise an indication of the prediction information. In some examples, a second message 702, may be transmitted from the UE 720 to the first network node 710 comprising an event trigger based on a radio signal measurement predicted by the UE 720 using the prediction information.

A third message 703 is transmitted from the first network node 710 to user equipment 720. The third message 703 comprises prediction information update criteria. As will be described in more detail below, the prediction information update criteria may comprise any suitable criteria, which may indicate to the UE when updated prediction information is required. For example, the prediction information update criteria may comprise a UE operating state for which the prediction information is valid e.g. idle mode. In such examples, the prediction information update criteria may thus indicate to the UE 720 that if the UE is to switch to another operating state e.g. active mode, the UE 720 may request updated prediction information.

Thus, UE 720 may transmit a fourth message 704 to first network node 710 comprising a request for updated prediction information. For example, when the prediction information update criteria indicates that the prediction information is valid for the ideal operating state, the UE may transmit the fourth message 704 in response to the UE 720 transitioning from idle mode to active mode. In response to the fourth message, the first network node 710 may thus transmit a fifth message 705 to the UE 710 comprising updated prediction information (e.g. prediction information that is valid for the active mode).

Thus, in some examples, first network node may: transmit, to a wireless device, prediction information update criteria; receive, from the wireless device, based on the prediction update criteria, a request for updated prediction information; and transmit, to the wireless device, updated prediction information responsive to receiving the request. Thus, in some examples, a UE may: receive, from the first network node, one or more prediction information update criteria; detect a condition satisfying the one or more prediction information update criteria; transmit, to the wireless device, responsive to detecting the condition, a request for updated prediction information; and receive, from the first network node, updated prediction information responsive to the request.

In some examples, the prediction information update criteria may comprise a location within which the prediction information is valid. For example, the area may be a geographical area, or a radio-location area, such as, for example a set of cell identities.

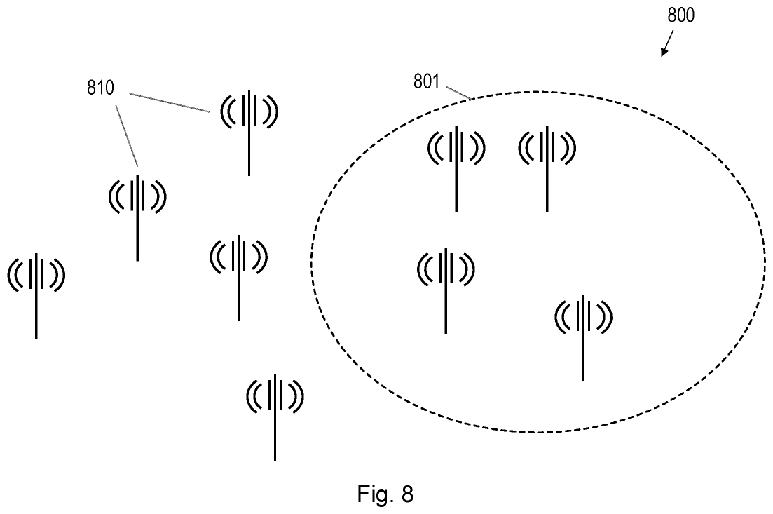

FIG. 8 illustrates an example network area 800 comprising a plurality of base stations 810. The prediction information update criteria may indicate that the prediction information is valid over geographical area 801. Thus, responsive to a UE leaving or moving close to the edge of geographical area 801, the UE may request updated prediction information based on geographical area information comprised in the prediction information update criteria.

In some examples, the validity of the prediction information over different geographical areas may be specific to different noising patterns. For example, the prediction information may indicate that a noising pattern can be used by the UE to predict a radio signal measurements over a particular geographic area e.g. area 801 of FIG. 8. However, the prediction information may indicate that another noising pattern can be used by the UE to predict a different radio signal measurement when the UE is outside of a particular geographic area e.g. area 801 of FIG. 8.

In some examples, the prediction information update criteria may comprise a time period during which the prediction information is valid. For example, the prediction information update criteria may comprise a timestamp indicating when the prediction information will become outdated. The UE may thus request updated prediction information when a time period, dictated by the timestamp, has expired.

As described above, in some examples, the prediction information provided by the network may be valid for a certain UE operating status, e.g. when the UE has a normal battery status. Thus the prediction information update criteria may indicate to the UE that when the UE operating status changes, e.g. the battery status of the UE becomes critical, the prediction information update criteria may indicate to the UE to request updated prediction information from the first network node.

Thus, in some examples, the prediction information update criteria may comprise at least one of: a location within which the prediction information is valid; a time period during which the prediction information is valid; and a wireless device operating state for which the prediction information is valid.

In some examples, a plurality of DAEs and noising patterns are downloaded by the UE from the first network node. The UE may then select a suitable combination of a DAE and noising pattern to form the prediction information based on the operating status of the UE. In some examples, prediction information comprising a single DAE is provided by the network to the UE, and the UE operating status may comprise one of the inputs of the DAE along with the radio signal measurements dictated by the noising pattern. For example, the DAE may be trained to predict radio signal measurements differently depending on the UE operating status.

In some examples, a plurality of DAEs and noising patterns may be pre-configured in a UE, for example, as part of standardisation documentations for each type of UE. For example, a first set of prediction information may be configured for an eMBB UE type and a second set of prediction information may be configured for a Redcap UE type. Thus, prediction information update criteria at the UE may indicate that when the UE type changes, e.g. from eMBB to Redcap the UE may use the second set of prediction information to predict a radio signal measurement instead of the first set of prediction information. In some examples, the UE may be of several types, e.g., eMBB and URLLC. In such examples, a first network node can control which prediction information the UE should use to predict a radio signal measurement. However, in other examples, the UE may be pre-configured with prediction information selection criteria to select the appropriate prediction information for predicting a radio signal measurement based on the prediction information selection criteria. For example, the UE may be pre-configured with such prediction information selection criteria as part of a standardisation step.

In some examples, the first network node may indicate the prediction information to the UE via a bitfield. For example, a prediction information provision bitfield may be provided from the network to the UE. Included within the prediction information provision bitfield may be a number of bitfields specifying one or more DAEs and noising patterns. The bitfield may further comprise information indicating to the conditions under which a DAE and noising pattern may be used to predict a radio signal measurement. Furthermore, in some examples, additional bitfields may be included within the model provision bitfield, which can indicate to the UE the set of parameters that the UE may use to calibrate a DAE model, for use to predict a radio signal measurement. However, in other examples, where the UE may perform at least some of the training of the DAE, for example, as part of the federated learning process described above, the first network node may omit, in part or as a whole, a bitfield that may be used to calibrate a given DAE.

In some examples, the network can include the prediction information provision bitfield as part of the SI, for example if the prediction information is to be broadcast to a plurality of UEs within a specific geographical area, to a certain number of cells, or to UEs associated with a specific number of base stations. In such examples, either the prediction information provision bitfield can be provided as part of a SIB, e.g., SIB2, or a new SIB is specifically designed for provisioning the prediction information. In some examples, the new SIB can be designed to be requested on-demand by the UE, or the network may send the SIB periodically, depending on the frequency with which the prediction information may be updated. However, in some examples, dedicated signalling, e.g., RRC signalling, or RRC release (in case of transition from connected to idle or inactive modes) can be used if the model is intended to be UE-specific.

In some examples, the network can also use a medium access control (MAC) control element (CE), or digital carrier interface (DCI) signalling in order to indicate to a UE to use a particular DAE and/or at least one candidate noising pattern for the prediction information or to update the prediction information. For example, the UE may be configured with a number of DAEs and the network can use MAC CE or DCI signalling in order to control the UE to use a certain DAE and/or noising pattern for the prediction information. In some examples, a specific application delay may be included in the MAC CE or DCI signalling.

In some examples, the UE may be connected to multiple base stations, for example, as part of a cell-free network, or a distributed Multiple Input Multiple Output (MIMO) network. In such examples, the network may coordinate training of a DAE to predict radio signal measurements between each of the multiple base stations and provide prediction information to the UE that may predict radio signal measurements between the UE and each of the base stations. In another example, each base station may individually provide prediction information to the UE for allowing the UE to predict a radio signal measurement between the UE and each respective base station. In such examples, to avoid the UE having to use multiple sets of prediction information, which may increase computational load for the UE, the UE may select prediction information from the multiple sets of prediction information based on a condition, for example the UE may opt to use the prediction information received from the base station with the strongest received channel quality, e.g., highest Signal to interference and noise ratio (SINR).

Examples according to the present disclosure thus provision a UE with prediction information for allowing a UE to predict a radio signal measurement. In some examples, predicting a radio signal measurement, as opposed to measuring the measurement, may save power at the UE thus improving UE energy efficiency. Furthermore, the prediction information may be obtained based on UE capability information. As such the prediction information may be obtained taking into account UE-specific needs, which may thus lead to more accurate radio signal measurement predictions or prediction information that may be used more frequently by a UE, or may lead to even greater power saving and/or efficiency at the UE.

Examples according to the present disclosure also enable the UE to trigger events, such as, mobility events or beamforming events based on the predicted radio signal measurements. This leads to improved mobility and beamformed data transmission performance when compared to other measurement relaxation methods in which the UE may be relying on old measurements as opposed to predicting the measurements in real-time.

Examples according to the present disclosure provide prediction information that can indicate to the UE which radio signal measurements can be predicted and which must be measured to provide the prediction. Ensuring that the appropriate resources are measured for a prediction may thus minimize outage and/or service degradation time compared to conventional prediction techniques where inappropriate predictions can result in outages and/or service degradation.

Examples according to the present disclosure also provide for more accurate radio signal measurement performance in some examples. For example, depending on the number of receiver chains at the UE antenna array, the UE may only be able to perform measurements on a subset of the frequencies being used to transmit relevant radio signal measurements. Examples according to the present disclosure can enable the UE to predict the radio signal measurements being transmitted on frequencies that it may not be able to measure due to a limited number of receiver chains.

### UE Assessment to Use Prediction Information

Examples present above thus describe how prediction information may be obtained based on UE capability information. However, according to further examples of the present disclosure, the UE may assess whether to use such prediction information to predict a radio signal measurement.

As described above, in some known radio signal prediction schemes, the configuration of a UE to predict a radio signal measurement is controlled by the network. The network, however, is unaware of UE performance requirements, such as QoS targets. As such, in order to meet such targets it may be beneficial for the UE not to predict a radio signal measurement due to reconstruction error associated with a prediction. However, the network may already have provisioned the UE to perform such a prediction, which may detrimentally affect such QoS targets.

Thus, examples of the present disclosure provide a method by which the UE can assess whether to predict the radio signal measurement based on local criteria associated with the UE, for example, QoS targets. In this way, the UE can control whether to predict a radio signal measurement or not based on the UE's own requirements. For example, after having been provisioned with prediction information, the local criteria may indicate that a high QoS target must be met. In such examples, the UE may therefore elect not predict a radio signal measurement.

However, in other examples, where the local criteria indicates that the QoS target is low, the UE may elect predict a radio signal measurement, which may save power and thus improve UE efficiency.

It will be appreciated that the UE may have local criteria associated with the UE (e.g. criteria associated with a high QoS scenario, a criteria associated with sleep mode operation etc.), that the UE may employ in different scenarios in order to determine whether to utilise prediction information to predict a radio signal measurement.

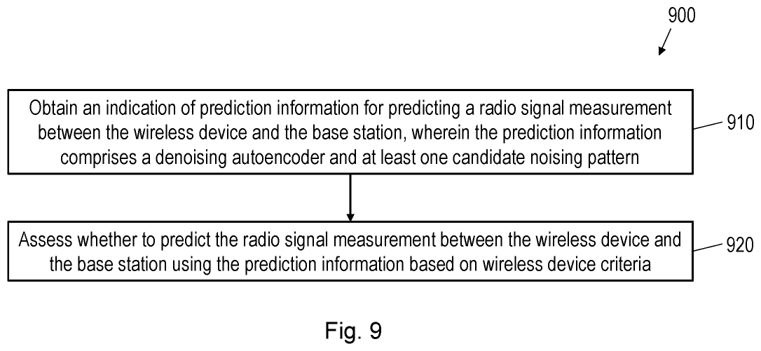

FIG. 9 is a flow chart illustrating process steps in a computer-implemented method 900 performed by a wireless device, for assessing whether to predict a radio signal measurement between the wireless device and a base station. It will be appreciated that the wireless device performing the method of FIG. 9 may also be configured to perform the method of FIG. 2 in tangent with the method of FIG. 9. The base station that the wireless device performing the method of FIG. 9 is communicating with may, in some examples, be configured to perform the method as described above with reference to FIG. 1.

The method 900 comprises, in step 910, obtaining an indication of prediction information for predicting a radio signal measurement between the wireless device and the base station, wherein the prediction information comprises a denoising autoencoder (DAE) and at least one candidate noising pattern. For example, the indication of the prediction information may be obtained by the wireless device in a transmission from a first network node. It will be appreciated that the indication of the prediction information may comprise the prediction information itself or control information, as described previously.

The method 900 further comprises, in step 920, assessing whether to predict the radio signal measurement between the wireless device and the base station using the prediction information based on one or more local criteria associated with the wireless device. For example, the one or more local criteria may comprise a QoS target, as described above.

The UE may thus assess whether to predict a radio signal measurement using the prediction information based on one or more local criteria associated with the UE. In some examples, the local criteria may comprise:
Sleep mode information, for example based on measure or sleep timeframes
Received noising pattern information from a first network node e.g. based on the reconstruction error associated with each noising pattern
Battery status
service type
QoS target
UE device type
Estimate of achievable power savings from different noising patterns

Thus, in some examples, the one or more local criteria associated with the wireless device may comprise at least one of: a sleep mode criterion; a battery status criterion; a Quality of Service, QoS, criterion; a wireless device type criterion; a wireless device service type criterion; a wireless device location criterion; a power saving criterion.

As described above, in some examples, when the UE is not in ongoing data transmission, predicting measurements is of most use if the UE can predict a first or last) SSB beams in a measurement window. Predicting the first or last SSB may, in some examples, allow the UE to spend a greater period of time in deep sleep. Predicting the first SSB beam may allow the UE to stay in deep sleep for longer after the start of the measurement window and predicting the last SSB beam may allow the UE to switch to deep sleep earlier before the end of the measurement window. This is in contrast to predicting SSB beams in the middle of a measurement window, which in some examples, may only allow the UE to perform micro-sleep within the measurement window. In some examples, micro-sleep may provide some energy saving benefit for the UE. However, the energy saving gains from a micro-sleep, in some examples may not be as great as for a UE deep sleep operation.

Thus, in some examples, a UE power saving criterion may thus assess whether predicting a radio signal measurement may reduce the time of an operation for the UE, or whether predicting a radio signal measurement may provide the UE with reduced activity during an operation, but would not reduce the time of the operation for the UE.

For example, predicting a first or last SSB beam in a measurement window may reduce the time of the operation of the UE because the UE may remain in deep sleep for longer, as described above. However, predicting SSB beams in the middle of a measurement window may not reduce the time of the operation for the UE because the UE can only perform micro-sleep for such predictions and must still measure the first and last signal at the end of the measurement window. Thus, in some examples the UE may assess whether predicting a radio signal measurement using the prediction information may reduce the time of an operation of the UE based on the power saving criterion. The UE may then decide whether or not to utilize the prediction information based on whether or not any of at least one candidate noising pattern in the prediction information allows the UE to remain in a deep sleep mode for a longer period of time.

Thus, in some examples, the step of assessing whether to predict a radio signal measurement between the wireless device and the base station using the prediction information based on the one or more local criteria may comprise: identifying whether the prediction information can be used to predict a radio signal measurement occurring at a beginning or an end of a measurement window. In some examples, the step of assessing whether to predict a radio signal measurement between the wireless device and the base station using the prediction information based on the one or more local criteria may comprise: identifying whether the prediction information can be used to predict a plurality of radio signal measurements occurring adjacent one another in a measurement window. As described above, in some examples a noising pattern associated with predicting two or more radio signal measurements that are adjacent one another within a measurement window may be associated with greater power saving than a noising pattern associated with predicting two or more radio signal measurements that are non-adjacent. In other words, for a candidate noising pattern that only masks one measurement in the middle of a measurement window, the UE would only be able to enter a very short micro-sleep. However, if the candidate noising pattern masks two or more measurements next to each other within the measurement window, the UE would be able to enter a longer micro-sleep, which would be associated with greater power savings.

In some examples, the prediction information may further comprise a reconstruction error associated with each respective candidate noising pattern; and assessing whether to predict the radio signal measurement between the wireless device and the base station using the prediction information may be further based on the reconstruction error associated with each respective candidate noising pattern. For example, the local criteria may comprise a QoS target. In such examples, the UE may determine that a noising pattern associated with a low reconstruction error may provide an acceptable prediction accuracy for the QoS target and thus may predict a radio signal measurement. However, a noising pattern associated with a high reconstruction error may provide an unacceptable prediction accuracy for the QoS target and the thus UE may not predict a radio signal measurement in such circumstances.

In some examples, the UE may select a first noising pattern from the at least one candidate noising pattern, wherein the first noising pattern is configured to mask at least a first radio signal measurement. In some examples, selecting the first noising pattern may be based on at least one of the one or more local criteria. For example, the UE may be provisioned with a plurality of noising patterns and the first network node may transmit control information to the UE indicating a plurality of candidate noising patterns that the UE may use to predict a radio signal measurement. The UE may then select the first noising pattern from the indicated plurality of candidate noising patterns based on the one or more local criteria.

In another example, the UE may receive a plurality of candidate noising patterns from the first network node and may select the first noising pattern from the plurality of candidate noising patterns based on the one or more local criteria e.g. the power saving criterion.

In some examples, the UE, responsive to assessing that the one or more local criteria are satisfied, may predict the first radio signal measurement using the DAE and the first noising pattern. For example, the UE may determine that the prediction may satisfy the UE's current QoS target and/or result in improved power saving for the UE and may thus predict a radio signal measurement. In some examples, the UE may further detect an event trigger based on the predicted first radio signal measurement and transmit the event trigger to a second network node. In some examples the second network node may be the same as the first network node. In other examples, the first network node may comprise a core network node and the second network node may comprise the base station.

In some examples, the event trigger may comprise an indication that the event trigger is based on the predicted first radio signal measurement. As described above, based on a predicted radio signal measurement, the UE can trigger events such as report a new strongest SSB beam index. As further described above, the indication may indicate to the first network node to verify the accuracy of the radio signal measurement on which the event trigger is based.

As described above, in some examples, the UE may be pre-configured with a number of DAEs and noising patterns, for example as part of standardisation. In another example, the UE may be provisioned with a plurality of DAEs and noising patterns, transmitted from a first network node. In either case, the UE can choose which DAE and noising pattern to use as the prediction information (if any) based on the one or more local criteria described above, e.g., UE type, UE power status, UE capabilities, etc. Once the prediction information has been determined, the UE may inform the network of the prediction information that it has employed (if any) for example, in a configuration message.

In some examples, the network may accept the prediction information selected by the UE and send a response message accepting the prediction information to the UE. In some other examples, the network may reject the prediction information in the response message. For example, the network may determine that a more appropriate DAE and/or noising pattern should be used by the UE based on, for example, wireless device capability information described above. Thus, in some examples, in the response message, the network may reject the prediction information and suggest different prediction information for the UE to use for predicting a radio signal measurement. In some examples, the UE may subsequently assess the different prediction information against the one or more local criteria associated with the UE.

Thus, in some examples, responsive to assessing that the one or more local criteria are satisfied, the UE may transmit to a third network node a configuration message identifying the DAE and the first noising pattern. In some examples, the UE may further receive, from the third network node responsive to the configuration message, a response message accepting the use of the DAE and the first noising pattern. In some examples, the UE may further receive, from the third network node responsive to the configuration message, a response message rejecting the DAE and the first noising pattern and suggesting second prediction information for predicting a radio signal measurement.

It will be appreciated that in some examples, the wireless device configured to perform the method of FIG. 9 may also transmit wireless device capability information to a first network node as described with reference to FIGS. 1 and 2. The prediction information obtained by the wireless device in step 910 may therefore be obtained based on wireless device capability information as described with reference to FIGS. 1 and 2.

Examples of the present disclosure thus provision a UE with prediction information for allowing a UE to predict a radio signal measurement where the UE has the flexibility to assess whether to predict a radio signal measurement or not. The UE may make such an assessment based on the UE's own needs at a given moment in time. For example, the UE may decide that a radio signal measurement can be predicted for improved energy efficiency. However, the UE may also determine that a radio signal measurement cannot be predicted for example due to high QoS targets. The UE can thus take such a decision based on information not available to the network, such as battery status or QoS targets, which leads to the UE making a decision to predict a radio signal measurement tailored to the UE's needs.

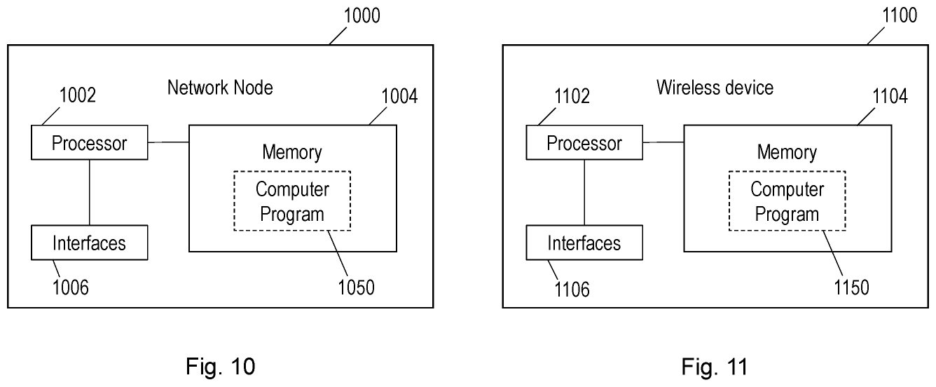

FIG. 10 is block diagram illustrating functional modules in a first network node 1000 which may implement the method 100, as illustrated in FIG. 1, according to examples of the present disclosure, for example on receipt of suitable instructions from a computer program 1050. Referring to FIG. 10, the first network node 1000 comprises a processor or processing circuitry 1002, and may comprise a memory 1004 and interfaces 1006. The processing circuitry 1002 is operable to perform some or all of the steps of the method 100 as discussed above with reference to FIG. 1. The memory 1004 may contain instructions executable by the processing circuitry 1002 such that the first network node 1000 is operable to perform some or all of the steps of the method 100 as discussed above with reference to FIG. 1. The instructions may also include instructions for executing one or more telecommunications and/or data communications protocols. The instructions may be stored in the form of the computer program 1050. In some examples, the processor or processing circuitry 1002 may include one or more microprocessors or microcontrollers, as well as other digital hardware, which may include digital signal processors (DSPs), special-purpose digital logic, etc. The processor or processing circuitry 1002 may be implemented by any type of integrated circuit, such as an Application Specific Integrated Circuit (ASIC), Field Programmable Gate Array (FPGA) etc. The memory 1004 may include one or several types of memory suitable for the processor, such as read-only memory (ROM), random-access memory, cache memory, flash memory devices, optical storage devices, solid state disk, hard disk drive etc. The first network node 1000 may further comprise interfaces 1006 which may be operable to facilitate communication with a wireless device and/or with other communication network nodes over suitable communication channels.

FIG. 11 is a block diagram illustrating an example wireless device 1100 which may implement the method 200, as illustrated in FIG. 2, according to examples of the present disclosure, for example on receipt of suitable instructions from a computer program 1150. Referring to FIG. 11, the wireless device 1100 comprises a processor or processing circuitry 1102, and may comprise a memory 1104 and interfaces 1106. The processing circuitry 1102 is operable to perform some or all of the steps of the method 200 as discussed above with reference to FIG. 2. The memory 1104 may contain instructions executable by the processing circuitry 1102 such that the wireless device 1100 is operable to perform some or all of the steps of the method 200 as discussed above with reference to FIG. 2. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc. The wireless device 1100 may further comprise interfaces 1106 which may be operable to facilitate communication with a first network node and/or with other communication network nodes over suitable communication channels.

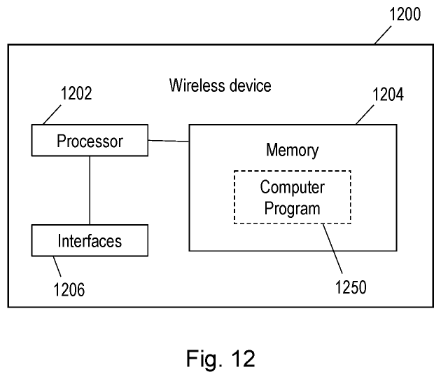

FIG. 12 is a block diagram illustrating an example wireless device 1200 which may implement the method 900 as illustrated in FIG. 9, according to examples of the present disclosure, for example on receipt of suitable instructions from a computer program 1250. Referring to FIG. 12, the wireless device 1200 comprises a processor or processing circuitry 1202, and may comprise a memory 1204 and interfaces 1206. The processing circuitry 1202 is operable to perform some or all of the steps of the method 900 as discussed above with reference to FIG. 9. The memory 1204 may contain instructions executable by the processing circuitry 1202 such that the wireless device 1200 is operable to perform some or all of the steps of the method 900, as illustrated in FIG. 9. The instructions may also include instructions for executing one or more telecommunications and/or data communications protocols. The instructions may be stored in the form of the computer program 1250. In some examples, the processor or processing circuitry 1202 may include one or more microprocessors or microcontrollers, as well as other digital hardware, which may include digital signal processors (DSPs), special-purpose digital logic, etc. The processor or processing circuitry 1202 may be implemented by any type of integrated circuit, such as an Application Specific Integrated Circuit (ASIC), Field Programmable Gate Array (FPGA) etc. The memory 1204 may include one or several types of memory suitable for the processor, such as read-only memory (ROM), random-access memory, cache memory, flash memory devices, optical storage devices, solid state disk, hard disk drive etc. The wireless device 1200 may further comprise interfaces 1206 which may be operable to facilitate communication with a first network node, and/or with other communication network nodes over suitable communication channels.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method, performed by a first network node, for provisioning a wireless device with prediction information for allowing the wireless device to predict a radio signal measurement between the wireless device and a base station, wherein the prediction information comprises a denoising autoencoder and at least one candidate noising pattern, the method comprising:
receiving, from the wireless device, wireless device capability information;
obtaining, based on the wireless device capability information, the denoising autoencoder and/or the at least one candidate noising pattern for predicting a radio signal measurement; and
transmitting an indication of the prediction information to the wireless device.

2. A computer-implemented method according to claim 1, wherein the wireless device is preconfigured with a plurality of denoising autoencoders and associated candidate noising patterns, and wherein transmitting the indication of the prediction information to the wireless device comprises transmitting control information, based on the wireless device capability, to the wireless device, wherein the control information is configured to identify a denoising autoencoder and associated noising pattern preconfigured at the wireless device.

3. A computer-implemented method according to claim 1, wherein transmitting the indication of the prediction information to the wireless device comprises transmitting the prediction information to the wireless device.

4. A computer-implemented method according to claim 3, wherein transmitting the prediction information to the wireless device comprises transmitting a unicast transmission, broadcast transmission or a multicast transmission.

5. The computer-implemented method according to claim 4, wherein transmitting the prediction information to the wireless device comprises transmitting a broadcast transmission or a multicast transmission and wherein the denoising autoencoder and/or the at least one candidate noising pattern are obtained based on wireless device capability information received from a plurality of wireless devices.

6. A computer-implemented method according to claim 3, wherein obtaining the denoising autoencoder and/or the at least one candidate noising pattern comprises training the denoising autoencoder to predict a radio signal measurement based on each of the at least one candidate noising pattern.

7. A computer-implemented method according to claim 6, wherein training the denoising autoencoder to predict a radio signal measurement based on each of the at least one candidate noising pattern comprises:
obtaining a plurality of sets of radio signal measurements between the wireless device and the base station;
applying each of a plurality of initial noising patterns to one or more of the plurality of sets of radio signal measurements to generate a noised dataset, wherein each of the plurality of initial noising patterns masks at least one radio signal measurement when applied to a set of radio signal measurements;
training the denoising autoencoder to predict the at least one masked radio signal measurement for each initial noising pattern;
determining a respective reconstruction error of the denoising autoencoder associated for each respective initial noising pattern; and
identifying the at least one candidate noising pattern from the plurality of initial noising patterns based on the respective reconstruction errors associated with the plurality of initial noising patterns.

8. A computer-implemented method according to claim 7, wherein the at least one masked radio signal measurement for each initial noising pattern is masked with a defined value that is the same for each of the plurality of initial noising patterns.

9. A computer-implemented method according to claim 7, wherein the step of identifying the at least one candidate noising patterns comprises:
for each initial noising pattern:
determining whether the reconstruction error associated with the initial noising pattern meets an accuracy criterion; and
responsive to the reconstruction error associated with the initial noising pattern meeting the accuracy criterion, identifying the initial noising pattern as one of the at least one candidate noising patterns.

10. A computer-implemented method according to claim 7, wherein the prediction information further comprises the respective reconstruction errors associated with each respective candidate noising pattern.

11. A computer-implemented method according to claim 7, wherein training the denoising autoencoder to predict the at least one masked radio signal measurement for each initial noising pattern comprises:
transmitting the denoising autoencoder and the plurality of initial noising patterns to the wireless device, wherein the wireless device is configured to apply the plurality of initial noising patterns to a second plurality of sets of radio signal measurements between the wireless device and the base station to generate a second noised dataset, and train the denoising autoencoder to predict at least one masked radio signal measurement for each initial noising pattern from the second noised dataset;
receiving, from the wireless device, an updated denoising autoencoder and updated respective reconstruction errors of the denoising autoencoder associated for each respective initial noising pattern based on the wireless device training; and
identifying the at least one candidate noising pattern from the plurality of initial noising patterns based on the updated respective reconstruction errors associated with the plurality of initial noising patterns.

12. A computer-implemented method according to claim 1, wherein each candidate noising pattern is a unique configuration to mask one or more radio signal measurements in a set of radio signal measurements.

13. A computer-implemented method according claim 1, wherein obtaining the denoising autoencoder and/or the at least one candidate noising pattern comprises selecting, based on the wireless device capability information, the denoising autoencoder and/or the at least one candidate noising pattern from a plurality of pre-trained denoising autoencoders each associated with at least one predetermined candidate noising pattern.

14. A computer-implemented method according to claim 1, wherein the step of obtaining the at least one candidate noising pattern further comprises obtaining the at least one candidate noising pattern based on predicted power saving performances for the wireless device associated with each candidate noising pattern.

15. A computer-implemented method according to claim 14, wherein a first noising pattern configured to mask one or more radio signal measurements that are at a beginning or an end of a measurement window is associated with a greater power saving performance than a second noising pattern configured to mask one or more radio signal measurements that are not at the beginning or the end of the measurement window.

16.-23. (canceled)

24. A first network node for provisioning a wireless device with prediction information for allowing the wireless device to predict a radio signal measurement between the wireless device and a base station, wherein the prediction information comprises a denoising autoencoder and at least one candidate noising pattern, the first network node comprising processing circuitry configured to:
receive, from the wireless device, wireless device capability information;
obtain, based on the wireless device capability information, the denoising autoencoder and/or the at least one candidate noising pattern for predicting a radio signal measurement; and
transmit an indication of the prediction information to the wireless device.

25. (canceled)

26. A computer-implemented method, performed by a wireless device, for obtaining prediction information for allowing the wireless device to predict a radio signal measurement between the wireless device and a base station, wherein the prediction information comprises a denoising autoencoder and at least one candidate noising pattern, the method comprising:
transmitting, to a first network node, wireless device capability information; and
receiving, from the first network node, an indication of the prediction information, wherein the prediction information is obtained based on the wireless device capability information.

27.-42. (canceled)

43. A wireless device for obtaining prediction information for allowing the wireless device to predict a radio signal measurement between the wireless device and a base station, wherein the prediction information comprises a denoising autoencoder and at least one candidate noising pattern, the wireless device comprising processing circuitry configured to:
transmit, to a first network node, wireless device capability information; and
receive, from the first network node, an indication of the prediction information, wherein the prediction information is obtained based on the wireless device capability information.

44.-61. (canceled)

62. A computer program product comprising a non-transitory computer readable medium, the computer readable medium having computer readable code embodied therein, the computer readable code being configured such that, on execution by a suitable computer or processing circuitry, the computer or processing circuitry is caused to perform a method as claimed in claim 1.

63. A computer program product comprising a non-transitory computer readable medium, the computer readable medium having computer readable code embodied therein, the computer readable code being configured such that, on execution by a suitable computer or processing circuitry, the computer or processing circuitry is caused to perform a method as claimed in claim 26.
